(19) United States
(12) Patent Application Publication
(10) Pub. No.: US 2007/0234968 A1
(43) Pub. Date: Oct. 11, 2007

(54) PET GROOMING BAG

(76) Inventor: SANDRA JEAN KERSTEN, VAIL, AZ (US)

Correspondence Address: DALE F. REGELMAN, LAW OFFICE OF DALE F. REGELMAN, P.C., 4231 SOUTH FREMONT AVENUE, TUCSON, AZ, 85714, US

(21) Appl. No.: 11/697,250

(22) Filed: Apr. 5, 2007

Related U.S. Application Data
(60) Provisional application No. 60/789,735, filed on Apr. 5, 2006.

(51) Int. Cl. A01K 13/00

(52) U.S. Cl. 119/600; 119/850

(57) ABSTRACT

A pet grooming bag is disclosed. The pet grooming bag provides a comfortable and private enclosure for the pet, wherein the interior of the bag comprises a plurality of combing protuberances that groom the pet. In certain embodiments, the pet grooming bag comprises a first fabric enclosure removeably disposed within a second fabric enclosure. In certain of these two enclosure embodiments, the interior of the assembly comprises a plurality of combing protuberances that groom the pet.

### CROSS REFERENCE TO RELATED APPLICATIONS

This Application claims priority from a U.S. Provisional Application having Ser. No. 60/789,735, filed Apr. 5, 2006.

### BACKGROUND OF THE INVENTION

Indoor pets, such as dogs and cats, sometimes have a favorite location in the house in which to sleep or rest. Sometimes these favored locations happen to be a soft chair seat, or a bed. During certain times during the year, considerable amounts of fur can be shed onto the furniture items.

As a result, pet owners would prefer that their pets not rest on furniture. As a result, many people have provided baskets, beds or other comfortable habitats for their pet, which usually are conveniently located for the pet and which are in a location out of the activity area for the humans in the household.

While such prior art pet beds and other similar items are useful, they usually are made from hard material such as wicker or plastic with a soft insert such as a pillow or blanket material. These relatively rigid structures are sometimes inconvenient to handle when being transported in the family car, etc., and these structures usually do not provide a means for the pet to burrow under a layer of material to keep warm. Indoor pets frequently become acclimatized to household temperatures in the range from about 65° F. to about 75° F., and continuing exposure to lower temperatures may cause the pet to become susceptible to illness. This susceptibility becomes more acute as the animal ages.

### SUMMARY OF THE INVENTION

Applicant's invention comprises a pet grooming bag, wherein the bag provides a comfortable and private enclosure for the pet, and wherein the interior of the bag comprises a plurality of combing protuberances that groom the pet. In certain embodiments, Applicant's pet grooming bag comprises a first fabric enclosure removeably disposed within a second fabric enclosure. In certain of these two enclosure embodiments, the interior of the assembly comprises a plurality of combing protuberances that groom the pet.

### BRIEF DESCRIPTION OF THE DRAWINGS

The invention will be better understood from a reading of the following detailed description taken in conjunction with the drawings in which like reference designators are used to designate like elements, and in which:

FIG. 1A is a perspective view of Applicant's pet grooming bag showing a plurality of combing protuberances disposed on the interior surface;

FIG. 1B shows a second fabric enclosure removeably disposed within a first fabric enclosure;

FIG. 2A is a perspective view of the first fabric enclosure;

FIG. 2B shows the construction of the first fabric enclosure;

FIG. 3A is a perspective view of the second fabric enclosure;

FIG. 3B shows the interior of the second fabric enclosure comprising a plurality of inwardly oriented combing protuberances;

FIG. 4 shows the second fabric enclosure being removeably disposed within the first fabric enclosure;

FIG. 5 is a side view showing a plurality of combing protuberances disposed on the interior portion of Applicant's inner fabric enclosure and extending outwardly therefrom.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

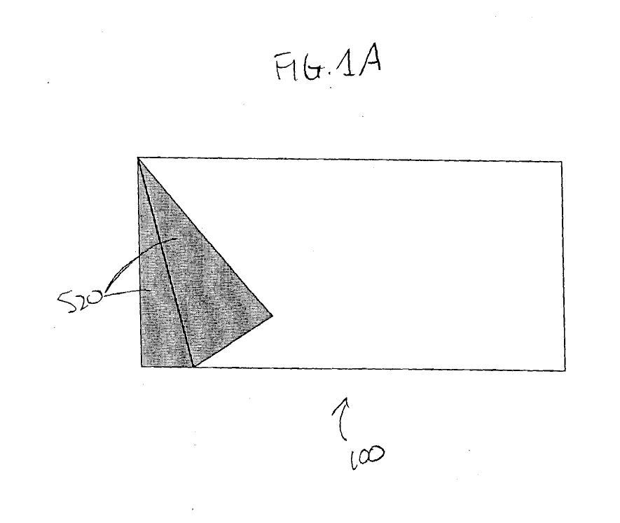

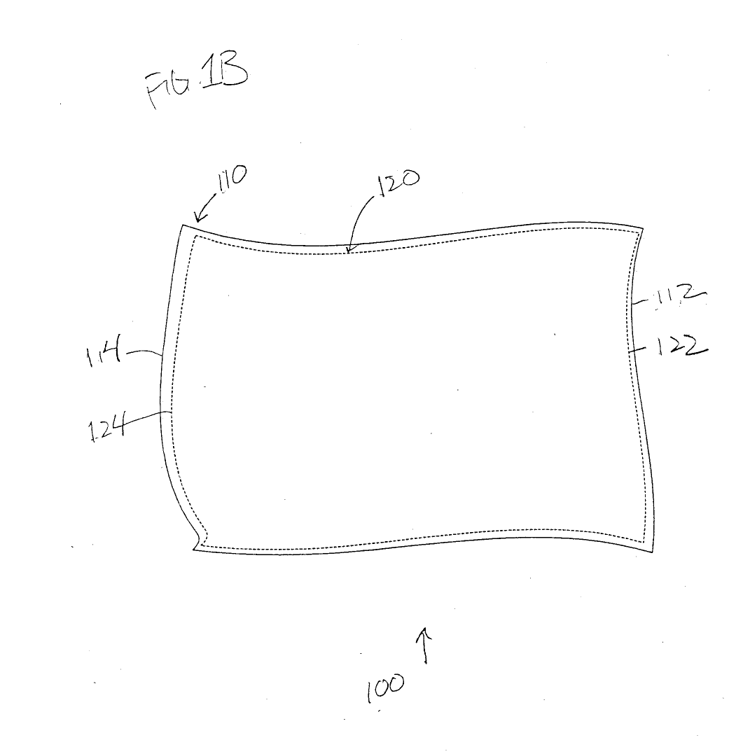

Applicant's invention comprises a pet grooming bag, wherein the bag provides a comfortable and private enclosure for the pet, and wherein the interior of the bag comprises a plurality of combing protuberances that groom the pet. For example and referring to FIG. 1A, Applicant's pet grooming bag 100 comprises a plurality of combing protuberances 520 disposed on the interior, wherein as the pet moves over and across that plurality of combing protuberances, loose fur, dust, dander, dirt, and the like, is removed from the pet's coat.

Referring now to FIG. 1B, in certain embodiments Applicant's pet grooming bag assembly 100 comprises an inner fabric enclosure 120 disposed within an outer fabric enclosure 110. By “fabric,” Applicant means a flexible, planar material formed by weaving or felting or knitting or crocheting natural and/or synthetic fibers. By “fabric enclosure,” Applicant means an assembly formed from a fabric, wherein that assembly comprises an enclosed space and an opening.

In the illustrated embodiment of FIG. 1B, fabric enclosure 110 comprises bottom 112 and open end 114. In certain embodiments, fabric enclosure 110 is formed from cotton fabric. In certain embodiments, fabric enclosure 110 is formed from nylon fabric. In certain embodiments, fabric enclosure 110 is formed from canvas. In certain embodiments, fabric enclosure 110 is formed from rayon fabric. In certain embodiments, fabric enclosure 110 is formed from polyester fabric. In certain embodiments, fabric enclosure 10 is formed from synthetic lambskin.

Fabric enclosure 120 comprises bottom 122 and open end 124. In certain embodiments, fabric enclosure 120 is formed from cotton fabric. In certain embodiments, fabric enclosure 120 is formed from nylon fabric. In certain embodiments, fabric enclosure 120 is formed from canvas. In certain embodiments, fabric enclosure 120 is formed from rayon fabric. In certain embodiments, fabric enclosure 120 is formed from polyester fabric. In certain embodiments, fabric enclosure 120 is formed from synthetic lambskin.

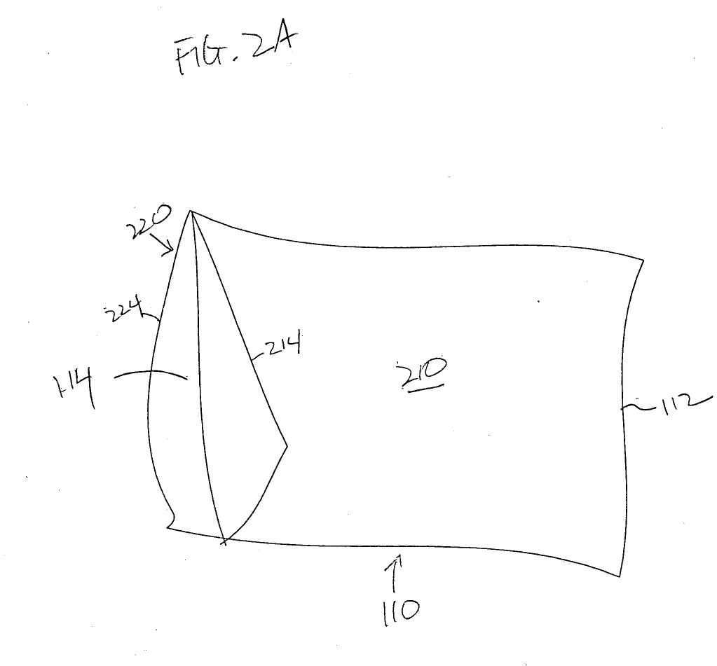

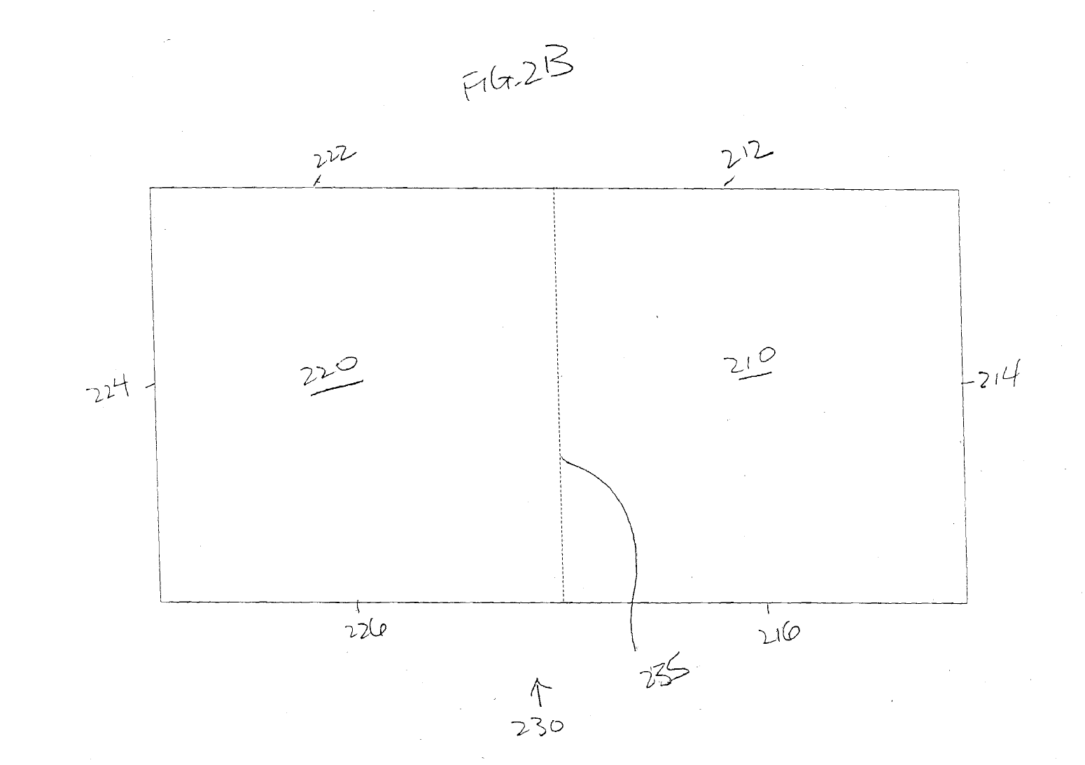

Referring now to FIG. 2A, in certain embodiments fabric enclosure 110 is formed from first rectangular fabric sheet 210 and second rectangular fabric sheet 220, wherein sheet 210 and 220 are joined to one another along three sides to form the fabric enclosure 110 having open end 114.

Referring to FIG. 2B, in certain embodiments a single fabric sheet 230 is folded at center line 235 and portion 210 is overlaid onto portion 220, and wherein edge 212 is joined to edge 222, and wherein edge 216 is joined to edge 226, and wherein edges 214 and 224 are not joined, to form fabric enclosure 110 comprising bottom 112 and open end 114.

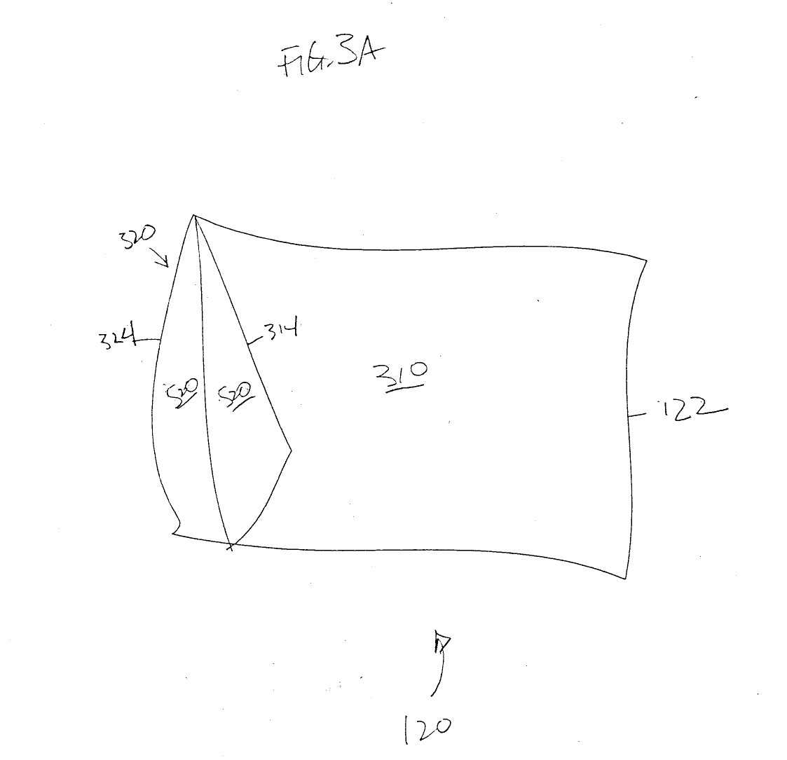

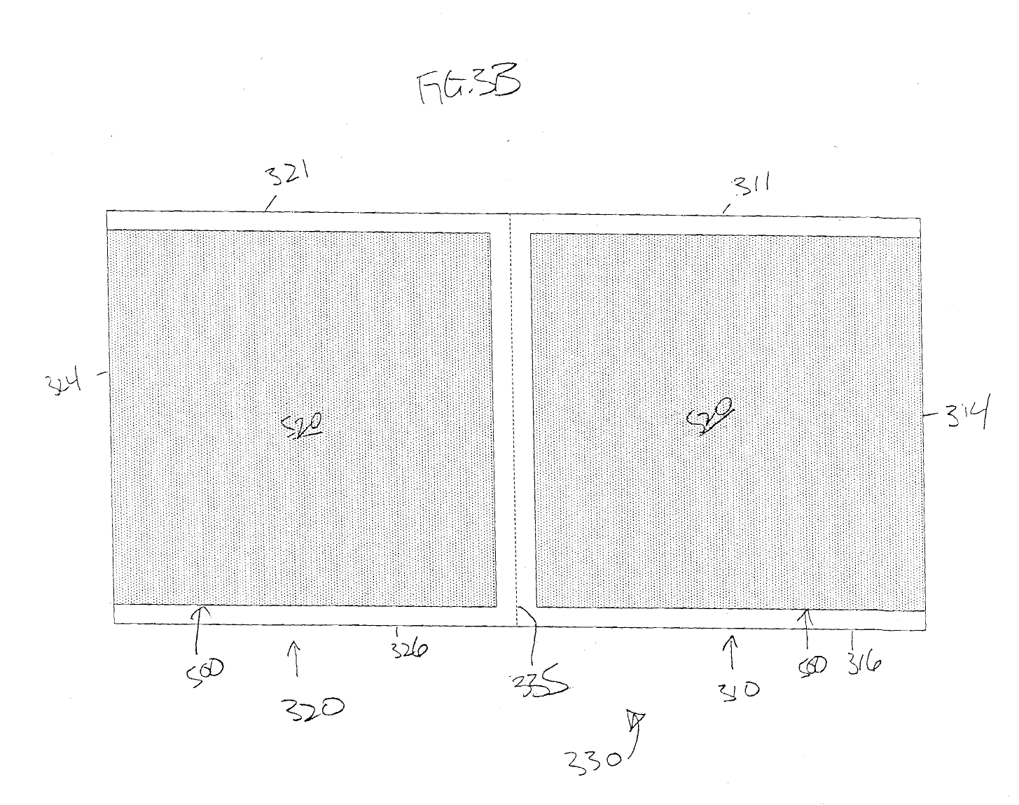

Referring now to FIG. 3A, in certain embodiments fabric enclosure 120 is formed from first rectangular fabric sheet 310 comprising surface 312, and second rectangular fabric sheet 320 comprising surface 322, wherein sheet 310 and 320 are joined to one another along three sides to form the fabric enclosure having open end 124, such that surface 312 is disposed within the enclosure, and such that surface 322 is disposed within the enclosure.

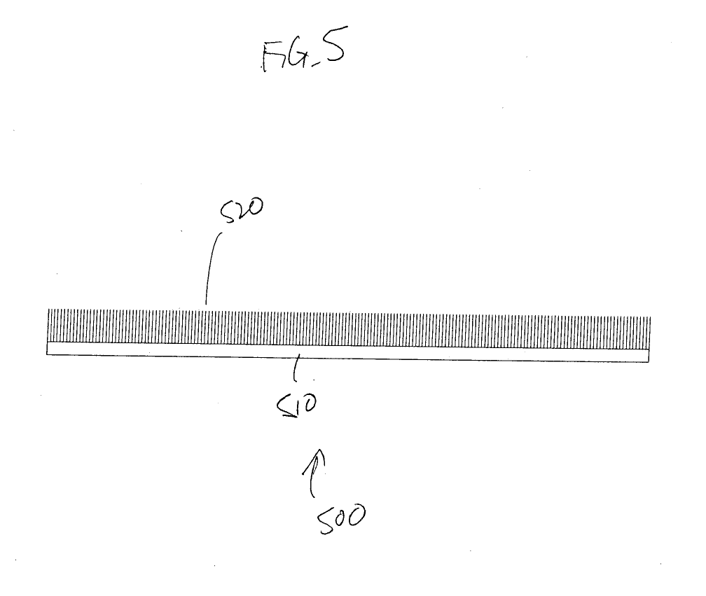

Referring to FIG. 3B, in certain embodiments a single fabric sheet 330 is folded at center line 335, and portion 310 comprising assembly 500 (FIG. 5) is overlaid onto portion 220 comprising assembly 500 (FIG. 5), wherein edge 311 is joined to edge 321, and wherein edge 316 is joined to edge 326, and wherein edges 314 and 324 are not joined, to form fabric enclosure 120, wherein the interior of fabric enclosure 120 comprises a plurality of inwardly oriented combing protuberances 520. In certain embodiments, more than about 90 percent of the interior of fabric enclosure 120 comprises a plurality of inwardly oriented combing protuberances 520. In certain embodiments, about 50 percent of the interior of fabric enclosure 120 comprises a plurality of inwardly oriented combing protuberances 520. In certain embodiments, less than about 50 percent of the interior of fabric enclosure 120 comprises a plurality of inwardly oriented combing protuberances 520.

In certain embodiments, Applicant's pet grooming bag 100 consists of fabric enclosure 120 described hereinabove. In other embodiments, Applicant's pet grooming bag 100 comprises fabric enclosure 110 in combination with fabric enclosure 1120.

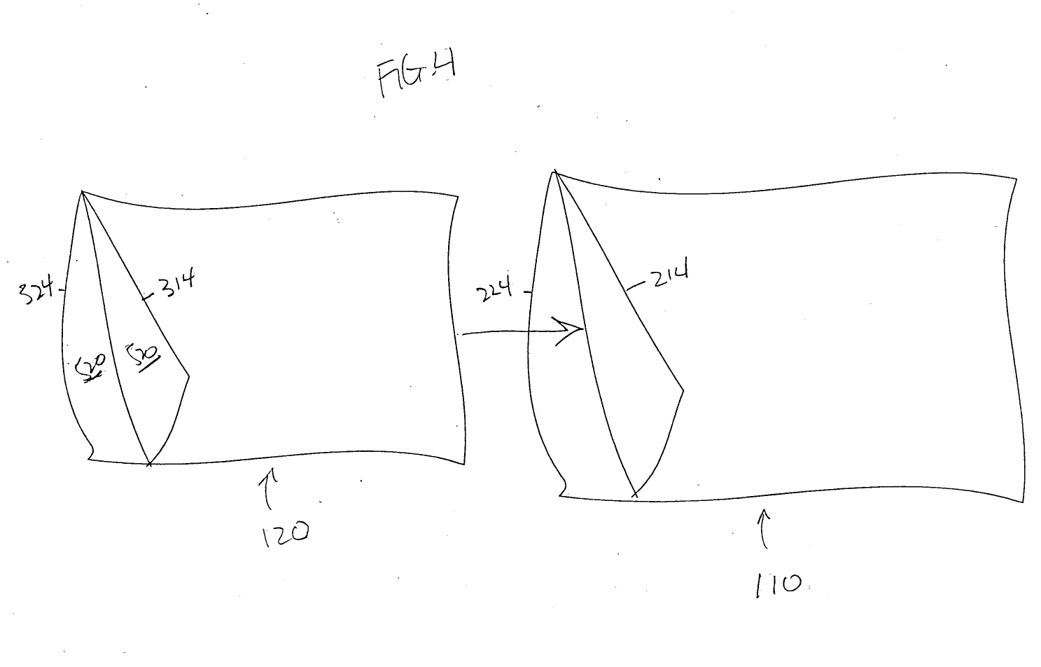

Referring to FIG. 4, in certain embodiments assembly 100 (FIG. 1) is formed by inserting fabric enclosure 120 into fabric enclosure 110. In these embodiments, the interior of assembly 100 comprises plurality of combing protuberances 520. In certain of these embodiments, fabric enclosure 120 can be entirely removed from fabric enclosure 110, and then enclosure 110 and/or enclosure 120 can be washed and/or replaced.

In certain embodiments, fabric enclosure 120 is disposed within fabric enclosure 110, and edge 214 is releaseably attached to edge 314 using one or more zippers, buttons, snaps, hook and loop fasteners, and the like, and edge 224 is releaseably attached to edge 324 using one or more zippers, buttons, snaps, hook and loop fasteners, and the like. In these embodiments, inner fabric enclosure 120 can be separated from outer enclosure 110 by releasing edge 214 from edge 314, and releasing edge 224 from edge 324.

Referring now to FIG. 5, assembly 500 comprises a substrate 510, with a plurality of combing protuberances 520 attached to substrate 510 and extending outwardly therefrom. In certain embodiments, substrate 510 comprises the interior surface of enclosure 120. In certain embodiments, the plurality of combing protuberances 520 comprise a plurality of flexible, cylindrical members extending outwardly from substrate 510, wherein those flexible, cylindrical members comprise a diameter between about 0.01 mm and about 1.0 mm, and a length between about 10 mm to about 50 mm.

In certain embodiments, the plurality of flexible members comprise the hardness of a rubber band, i.e. about a 35 Shore A hardness. In certain embodiments, the plurality of flexible members comprise the hardness of a rubber tire, i.e. about a 55 Shore A hardness. In certain embodiments, the plurality of flexible members comprise the hardness of a rubber shoe heel, i.e. about a 70 Shore A hardness.

In certain embodiments, the plurality of combing protuberances 520 comprise a plurality of fibers extending outwardly from substrate 510. In certain embodiments, the plurality of fibers comprise a plurality of nylon nanofibers comprising a diameter of about 500 nanometers.

In certain embodiments, the plurality of combing protuberances 520 comprise a plurality of electrostatic fibers. By “electrostatic fibers,” Applicant means fibers that are given permanent electrical charges to attract from the pet's coat loose pet fur, dander, dust, dirt, and the like. In certain embodiments, the plurality of combing protuberances 520 comprise a plurality of dielectric fibers. As taught by Savell, in U.S. Pat. No. 5,336,299, which is hereby incorporated herein by reference, movement through or against such dielectric fibers will generate friction that induces a static charge that builds up to become substantial enough to draw out from the pet's coat loose pet fur, dander, dust, dirt, and the like.

The plurality of combing protuberances 520 effectively comb the hair of the pet each time the pet moves within Applicant's pet grooming bag 100. When the pet crawls into Applicant's pet grooming bag 100, and during the pet's residence therein, the pet, through contact with the plurality of combing protuberances 520, will effectively receive a grooming of its outer coat. Not only will this provide a comfortable place for a pet to reside, but the pet's outer coat will be groomed to provide for elimination of shedding hair.

While the pet moves within the pet grooming bag 100, the plurality of combing protuberances 520 will collect loose pet fur, dander, dust, dirt, and the like, from the coat of the pet. The owner of the pet can then remove inner fabric enclosure 120 from pet grooming bag 100 when the plurality of combing protuberances 520 have been filled with the pet's hair.

While the preferred embodiments of the present invention have been illustrated in detail, it should be apparent that modifications and adaptations to those embodiments may occur to one skilled in the art without departing from the scope of the present invention as set forth in the following claims.

I claim:

1. A pet grooming bag, comprising:
a fabric enclosure formed to include an open end, and comprises an interior;
a plurality of combing protuberances disposed on said interior and extending inwardly therefrom.

2. The pet grooming bag of claim 1, wherein said plurality of combing protuberances comprise a plurality of flexible, cylindrical members extending outwardly from said interior, wherein those flexible, cylindrical members comprise a diameter between about 0.01 mm and about 1.0 mm, and a length between about 10 mm to about 50 mm.

3. The pet grooming bag of claim 2, wherein said plurality of flexible, cylindrical members comprise a hardness of about 35 Shore A.

4. The pet grooming bag of claim 2, wherein said plurality of flexible, cylindrical members comprise a hardness of about 55 Shore A.

5. The pet grooming bag of claim 2, wherein said plurality of flexible, cylindrical members comprise a hardness of about 70 Shore A.

6. The wherein said plurality of combing protuberances comprise a plurality of fibers.

7. The pet grooming bag of claim 6, wherein said plurality of flexible, cylindrical members comprise a plurality of nylon nanofibers comprising a diameter of about 500 nanometers.

8. The pet grooming bag of claim 6, wherein said plurality of flexible, cylindrical members comprise a plurality of electrostatic fibers.

9. The pet grooming bag of claim 6, wherein said plurality of flexible, cylindrical members comprise a plurality of dielectric fibers.

10. A pet grooming bag, comprising:
a first fabric enclosure formed to include a first open end;
a second fabric enclosure formed to include a second open end;
wherein said first enclosure is removeably disposed within said second enclosure.

11. The pet grooming bag of claim 10, wherein said first enclosure comprises an interior, said pet grooming bag further comprising a plurality of combing protuberances disposed on said interior and extending inwardly therefrom.

12. The pet grooming bag of claim 11, wherein said plurality of combing protuberances comprise a plurality of flexible, cylindrical members extending outwardly from said interior, wherein those flexible, cylindrical members comprise a diameter between about 0.01 mm and about 1.0 mm, and a length between about 10 mm to about 50 mm.

13. The pet grooming bag of claim 12, wherein said plurality of flexible, cylindrical members comprise a hardness of about 35 Shore A.

14. The pet grooming bag of claim 12, wherein said plurality of flexible, cylindrical members comprise a hardness of about 55 Shore A.

15. The pet grooming bag of claim 12, wherein said plurality of flexible, cylindrical members comprise a hardness of about 70 Shore A.

16. The pet grooming bag of claim 11, wherein said plurality of combing protuberances comprise a plurality of fibers.

17. The pet grooming bag of claim 16, wherein said plurality of flexible, cylindrical members comprise a plurality of nylon nanofibers comprising a diameter of about 500 nanometers.

18. The pet grooming bag of claim 16, wherein said plurality of flexible, cylindrical members comprise a plurality of electrostatic fibers.

19. The pet grooming bag of claim 16, wherein said plurality of flexible, cylindrical members comprise a plurality of dielectric fibers.

20. The pet grooming bag of claim 9, wherein:
said first open end is defined by a first edge and a second edge;
said second open end is defined by a third edge and a fourth edge;
said first edge is releaseably attached to said third edge; and
said second edge is releaseably attached to said fourth edge.
